(19) United States
(12) Patent Application Publication
(10) Pub. No.: US 2015/0147710 A1
(43) Pub. Date: May 28, 2015

(54) LASER ETCHED SINTERED CERAMIC ORTHODONTIC BRACKETS

(71) Applicant: Paul Lewis, Midvale, UT (US)

(72) Inventor: Paul Lewis, Midvale, UT (US)

(73) Assignee: Ultradent Products, Inc., South Jordan, UT (US)

(21) Appl. No.: 14/237,963

(22) PCT Filed: Aug. 10, 2012
(86) PCT No.: PCT/US2012/050306

§ 371 Date: Jan. 19, 2015

Related U.S. Application Data
(60) Provisional application No. 61/522,895, filed on Aug. 12, 2011.

(51) Int. Cl. A61C 7/16; B23K 26/36; B23K 26/40

(52) U.S. Cl. CPC A61C 7/16; B23K 26/408; B23K 26/365
USPC 433/9; 264/16

(57) ABSTRACT

The present disclosure is drawn to laser etched, sintered ceramic orthodontic brackets. Such a bracket can comprise a working surface including an archwire slot and a ligating structure. The bracket can also include a laser etched tooth attachment surface that is laser etched after sintering of the ceramic orthodontic bracket. In another example, a method of increasing the average bonding strength of a sintered ceramic orthodontic bracket can comprise laser etching a tooth attachment surface of the sintered ceramic orthodontic bracket. In one specific example, the method can further comprise the preliminary steps of forming a ceramic material into a shape of an orthodontic bracket and sintering the orthodontic bracket.

### BACKGROUND

Orthodontic brackets have been manufactured from materials such as stainless steel, ceramic, as well as certain types of plastics or plastic composites. Each type of orthodontic bracket has certain positive characteristics as well as some drawbacks. For example, stainless steel brackets can be less comfortable for certain patients as well as more visibly noticeable. Further, though stainless steel is strong, this type of orthodontic bracket can cause adverse reactions to the patients due to contact with their trace metals. Conversely, brackets made of plastic materials, due to their relative lower strength, can exhibit permanent deformation during use. This failure is propagated by the stresses generated by the loading forces from active elements, such as archwire or masticatory forces. In more specific detail, brackets fabricated from polycarbonate demonstrate distortion under torsional loading generated by orthodontic archwires and also possess a high propensity for water absorption, which may result in discoloration of the bracket and undesired staining. Ceramic brackets, on the other hand, can be brittle and even small surface cracks (flaws) can dramatically reduce the load needed for fracture. Brackets that distort or fail during treatment minimize or render tooth movement ineffective, thereby extending treatment time.

Appropriate adhesive retention of an orthodontic bracket to a tooth can also play a role in successful orthodontic treatment. For example, if bracket adhesion to the tooth is too light, the orthodontic bracket can be pulled from the tooth prematurely. On the other hand, if adhesion is too strong, the bond itself may cause the enamel adhesive interface to be stressed during either debonding or a sudden occlusal force. Hence, irreversible damage to the enamel of the entire tooth may occur and is particularly significant when bonding endodontically treated teeth or teeth with large restorations. In addition, due to the hardness of certain brackets, abrasion during the chewing process can lead to enamel wear.

### SUMMARY

The present disclosure is drawn to laser etched, sintered ceramic orthodontic brackets. Such a bracket can comprise a working surface including an archwire slot and a ligating structure. The bracket can also include a laser etched tooth attachment surface that is laser etched after sintering of the ceramic orthodontic bracket.

In another example, a method of increasing the average bonding strength of a sintered ceramic orthodontic bracket can comprise laser etching a tooth attachment surface of the sintered ceramic orthodontic bracket. In one specific example, the method can further comprise the preliminary steps of forming a ceramic material into a shape of an orthodontic bracket and sintering the orthodontic bracket.

In another embodiment, an orthodontic system can comprise a sintered ceramic orthodontic bracket with a working surface including an archwire slot and a ligating structure, and a laser etched tooth attachment surface which is laser etched after sintering of the ceramic orthodontic bracket. The system can further include an adhesive for attaching the sintered ceramic orthodontic bracket to the enamel of a tooth. The laser etched tooth attachment surface combined with the adhesive can provide an average bonding strength of about 15 to about 40 pounds of force.

### DETAILED DESCRIPTION

Before the present invention is disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “average bonding strength” refers to the pounds of force required to remove a bracket adhered to a one inch diameter sand blasted (50 μm aluminum oxide) acrylic ball using an INSTRON® Machine Model No. 4442 averaged over 20 similarly prepared brackets. Specifically, once adhered to the acrylic ball, bonding strength is determined by wrapping a wire around each bracket and pulling on the bracket along a tangent line with respect to the acrylic ball until the bracket breaks free from the acrylic ball. Average bonding strength of a specific bracket is typically described in terms of the bonding strength provided by a specifically configured laser etched tooth attachment surface in combination with a specific bonding adhesive. However, in embodiments related specifically to the bracket where the adhesive is not specifically set forth, a standard average bonding strength is determined using Opal Bond MV adhesive (i.e. Bis GMA-based adhesive) from Ultradent Products, Inc. Alternatively, in system embodiments, various adhesives can be used and it is the combination of the bracket and the adhesive that provide average bonding strength values.

A “comparison” sintered ceramic orthodontic bracket is otherwise identical to the laser etched, sintered ceramic brackets of the present disclosure, except that they are not laser etched prior to determining average bonding strength. Comparison sintered ceramic brackets are not detailed herein for purposes of describing the present invention, but rather are described to compare how much bonding strength is increased on a case by case basis by the presence of the laser etched tooth attachment surface of the present disclosure.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional components, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

With these definitions in mind, development in the field of orthodontic appliances has provided many different types of brackets for adhesive bonding to teeth. Generally, an archwire, ligatures, self-ligating structures, etc., are secured to such brackets in a conventional manner for making orthodontic adjustments. In many instances, ceramic brackets can be particularly advantageous since this material has outstanding mechanical strength and is cosmetically acceptable.

Providing acceptable bonding strength between a ceramic orthodontic bracket and the enamel of a tooth can be difficult. To illustrate, bonding strength should be strong enough so as to allow a dental professional to manipulate the teeth of the patient without the orthodontic brackets becoming inadvertently debonded, and at the same time, not so strong that the enamel of the patient becomes damaged upon removal of the bracket. Finding acceptable bonding strength can be impacted by many variables, including tooth attachment surface area and/or curvature, material choice, adhesive choice, etc. Thus, finding a desired bonding strength can be challenging for a given bracket material, shape, size, and adhesive. In fact, often, the bonding strength of orthodontic brackets for each tooth type in the mouth is determined individually. With the many different tooth shapes and sizes of teeth, one simple formula for achieving appropriate bonding strength for each tooth can be impractical. For example, a specifically shaped and sized bracket may provide acceptable bonding strength for one tooth, but not work well on another tooth. However, in accordance with the present disclosure, by providing a laser etched tooth attachment surface, bonding strength can be more easily modulated on an individual bracket basis.

To illustrate, if it is desired to prepare an orthodontic bracket that has an average bonding strength in the vicinity of about 15 pounds of force to about 40 pounds of force (as defined herein), laser etching of an already sintered bracket can be used to increase bonding strength effect to a desirable average bonding strength within the desired range. For example, if the bonding strength of a ceramic orthodontic bracket that is not laser etched is 12 pounds of force with a given adhesive, laser etching a light pattern, e.g., a relatively small linear length of laser etched lines, in the tooth attachment surface can bring the bonding strength up to about 15 pounds of force, and a heavier pattern, e.g., more laser etched lines, can bring the bring the bonding strength up to about 30 pounds of force or even more. Likewise, if a different adhesive provides an inherent bonding strength of 18 pounds of force with the same bracket, for example, it still may be desirable to bring the bonding strength up to about 20 to about 35 (or 40) pounds of force through laser etching as described herein.

Thus, the pattern or linear length of laser etched “lines” can have an impact on how much the average bonding strength may be increased. For example, too much etching and/or the wrong adhesive combination may provide too much bonding strength, e.g., bonding strength that would damage the enamel when removed or pulled from the tooth. In other words, bonding strengths obtained which can compromise the safety margin of the stresses that can be withstood by the cohesive strength of enamel are undesirable. This may lead to enamel fracture. The incidence of fracture of ceramic brackets themselves can also be of concern. Notably, pieces of bracket may be ingested or inhaled inadvertently if fracture occurs in the mouth during or after treatment. Likewise, minimal etching with one or just a few “lines” can provide minimal increase in bonding strength. This may or may not be enough, depending on the circumstance. Sometimes, however, a small increase in bonding strength is all that is needed or desired to put a bracket into an acceptable range of bonding strength.

In accordance with this, it has been recognized that a sintered ceramic orthodontic bracket having a tooth attachment surface that is laser etched after sintering can provide an increase in bonding strength, as well as provide the ability to modulate bonding strength within a desired range over a relatively wide number of tooth shapes and related adhesives. More specifically, the present orthodontic brackets can provide appropriate bonding strength to withstand the forces upon the bracket while in use, and allow for safe removal of the bracket upon completion of the orthodontic treatment.

More specifically, the present disclosure is drawn to laser etched, sintered ceramic orthodontic brackets that comprise a working surface including an archwire slot and a ligating structure. The bracket also includes a laser etched tooth attachment surface that is laser etched after sintering of the ceramic orthodontic bracket.

In another example, a method of increasing the bonding strength of a sintered ceramic orthodontic bracket can comprise laser etching a tooth attachment surface of the sintered ceramic orthodontic bracket. The method can further comprise the preliminary steps of forming a ceramic material into a shape of an orthodontic bracket and sintering the orthodontic bracket.

In another embodiment, an orthodontic system can comprise a sintered ceramic orthodontic bracket with a working surface including an archwire slot and a ligating structure, and a laser etched tooth attachment surface which is laser etched after sintering of the ceramic orthodontic bracket. The system can further include an adhesive for attaching the sintered ceramic orthodontic bracket to the enamel of a tooth. The laser etched tooth attachment surface combined with the adhesive can provide an average bonding strength of about 15 to about 40 pounds of force. For convenience, the average bonding strength can be determined by applying the bracket to a one inch diameter, 50 μm aluminum oxide blasted acrylic ball (rather than a tooth), and average bonding strength determined by pulling the bracket along a tangential line from the circumference of the ball using an INSTRON® Machine Model No. 4442, averaged over 20 similarly prepared brackets.

Thus, the present disclosure is drawn to sintered ceramic orthodontic brackets and associated methods and systems. It is noted that when discussing the present sintered ceramic orthodontic brackets, as well as the associated methods and systems, each of these discussions can be considered applicable to each of these embodiments, whether or not they are explicitly discussed in the context of that example. For example, in discussing a ceramic material for use in the sintered ceramic orthodontic bracket, such a ceramic material can also be used for the method of manufacturing or the orthodontic system, and vice versa.

The sintered ceramic orthodontic bracket can include any type of ceramic material, including polycrystalline alumina, monocrystalline zirconia, or the like. In one embodiment, the ceramic material can include a polycrystalline alumina ceramic material. In another aspect, the entire orthodontic bracket can be ceramic; and in still another embodiment, the orthodontic bracket can include a ceramic base fused or attached to another material, e.g., ceramic bracket body and base with a metal slot liner, ceramic tooth attachment surface with a metal working surface, etc.

The sintered ceramic orthodontic brackets of the present disclosure generally include a working surface and a tooth attachment surface. The working surface is the surface that the dental professional has access to once the orthodontic bracket is attached to the tooth. For example, the working surface may include an archwire slot for receiving an archwire, tie wings for attaching ligatures, self-ligating structures, etc. The archwire slot can be of the ceramic material, or optionally, can include a slot liner for protecting the ceramic bracket. In one embodiment, the slot liner can be a metal slot liner, such as stainless steel, gold, white gold, or silver.

Generally, the ligating structure can be used for holding the archwire and/or for adjustment of the forces upon the bracket, translating to movement of the underlying tooth to which the bracket is bonded. In one embodiment, the ligating structure can include a plurality of tie wings. In another embodiment, the ligating structure can include a self-ligating structure. Regarding tie wing embodiments, these structures can be positioned adjacent to the archwire slot, and a groove can extend behind the tie wings for receiving a ligature. In use, the practitioner extends the ligature behind one or more of the tie wings and also over the archwire in order to retain the archwire in the archwire slot. If the practitioner elects to replace the archwire during the course of treatment, the ligature is removed from its position behind the tie wings in order to release the archwire from the archwire slot. In general, two types of orthodontic ligatures are common. One type of ligature resembles a tiny elastomeric O-ring, and is stretched during installation to fit behind the tie wings as well as over the archwire. When the elastomeric ligature is released, it contracts to hold the archwire in place. Another type of orthodontic ligature in common use is made of a segment of small-diameter metallic wire, and ends of the wire are twisted together to form a snug-fitting loop after the wire has been extended behind the selected tie wings and over the archwire.

Alternatively, rather than the use of tie wings and ligatures, some brackets are self-ligating. For example, some self-ligating orthodontic bracket can include a bracket body and a self-ligation component that is permanently attached to the bracket body to hold the archwire in place. Various techniques or mechanisms are used to hold the archwire in place, but regardless of how this is done, provided the tooth attachment surface is sintered ceramic, such brackets can benefit from laser etching in accordance with embodiments of the present disclosure. For example, a sintered ceramic orthodontic bracket with a self-ligating mechanism can be laser etched with from one to several laser etched lines.

Regardless of the type of bracket being used, the orthodontic brackets of the present disclosure can be generally bonded to the tooth via an adhesive. Any type of adhesive may be used that is of a suitable type for the sintered and post laser etched ceramic orthodontic brackets, and which will typically provide an appropriate bonding strength between the bracket and the tooth enamel that is strong enough to adhere acceptably, but weak enough to preserve tooth enamel when removed. Exemplary adhesives that can be used include bonding cement, bonding adhesives, etc. Specific examples of such adhesives include Opal Bond Opal Bond MV, Transbond XT, Reliance Light Bond, and the like. Materials present in such adhesives can include bisphenol A diglycidylether methacrylate, bisphenol A bis(2-hydroxyethyl ether)dimethacrylate, silane treated quartz, silica, alumina, silane treated silica or alumina, or mixtures thereof, to name a few.

As mentioned, the sintered ceramic orthodontic brackets have a laser etched tooth attachment surface. Though not required, the laser etched tooth attachment surface can provide an average bonding strength of about 15 to about 40 pounds of force when applied to a tooth surface with Opal Bond MV, which includes a Bis-GMA (bisphenol A diglycidylether methacrylate) monomer as part of the resin composite. In one aspect, the average bonding strength can be from about 20 to about 35 pounds of force, and in another aspect, the average bonding strength can be from about 22 to about 30 pounds of force. The use of this specific adhesive is not required, but rather, Opal Bond MV is mentioned and provided for purposes of determining the general bonding strength of certain laser etched sintered ceramic brackets in accordance with examples of the present disclosure. Thus, a specific bracket may be evaluated using this specific adhesive to see if it provides a given bonding strength described herein, though in practice, other adhesives might be used by the dental practitioner. In other words, this specific adhesive is provided for testing purposes only, and may or may not be used in practice. On the other hand, when referring to the orthodontic systems described herein where the adhesive is included as part of the disclosure, specific brackets and adhesives are included in combination to fall within specific average bonding strength ranges.

The tooth surface bonding strength is measured as an average bonding strength because no two structures provide the exact same results, but rather, approximate one another over multiple testing events. It is believed that 20 similarly prepared brackets can provide acceptable average numbers for predictable average bonding strength. Furthermore, for convenience, rather than using live teeth for testing, it makes practical sense to approximate the tooth surface by measuring the pounds of force required to remove a bracket using a similar structure. As described herein, one such standard is adherence to a one inch diameter, 50 μm aluminum oxide blasted acrylic ball (as this structure has a similar texture, relative curvature, etc., to some teeth).

In further detail, it has been discovered that the present sintered ceramic orthodontic brackets can provide an increase in bonding strength over brackets that are not laser etched. In one embodiment, the sintered ceramic orthodontic bracket can provide for an average bonding strength that is at least 1.05 times that of a comparison sintered ceramic bracket that is not laser etched. In another embodiment, the average bonding strength can be at least 1.2 times greater. In still another embodiment, the average bonding strength can be at least 1.4 times greater. In still another embodiment, the average bonding strength can be at least 2.0 times greater. Sometimes, the bonding strength only needs to be increased slightly to put it in an acceptable desired bonding strength range, and other times, more significant increases may be desired. By adjusting the total linear mm of etching lines on the tooth attachment surface, bonding strength can be modulated from just a slight increase (providing fewer linear millimeters of etching lines) to more significant bonding strength increase (providing a more linear millimeters of etching lines). Pattern of etching, choice of ceramic material and/or adhesive, area of tooth attachment surface, curvature of tooth attachment surface, or other factors can also play a role in bonding strength. However, in accordance with examples of the present disclosure, laser etching of an already sintered ceramic bracket provides a useful tool in obtaining more precise bonding strength with a given set of other parameters.

In one embodiment, the laser etched tooth attachment surface includes laser-generated cross-hatching. In another embodiment, the laser etched tooth attachment surface includes parallel lines. In yet another embodiment, the laser etched attachment surface includes a pre-determined pattern, such as a design, a trademark to be viewed by the dental practitioner prior to tooth attachment, or other more functional pattern. In each case, the laser etched tooth attachment surface can include from about 0.01 to about 10 linear mm of laser etched lines (including curved or straight lines). In another aspect, the laser etched tooth attachment surface can include from about 0.01 to about 5 linear mm of laser etched lines. In another aspect, the laser etched tooth attachment surface can include from about 0.02 to about 2 linear mm of laser etched lines. In yet another aspect, the laser etched tooth attachment surface can include from about 0.1 to about 1 linear mm of laser etched lines. Furthermore, the depth of the lines can also be kept within a desired range to provide an appropriate average bonding strength. For example, typical line depths may be from about 0.01 mm to about 1 mm, though depths from about 0.05 mm to about 0.3 mm may be more typical. These ranges of laser etched lines are not meant to be limiting, but rather describe exemplary ranges of lines that can be used.

Any type of laser device can be used to laser etch the sintered ceramic brackets disclosed herein, provided the laser energy provides enough power to etch the tooth attachment surface of an already sintered orthodontic bracket. For example, more power would typically be used for laser etching the tooth attachment surface of a sintered bracket in accordance with the present disclosure than would be used to laser etch green body ceramic. Green body ceramic may only require less than a watt to only a few watts of energy to modify the surface, whereas a more appropriate power setting for application of laser energy in accordance with embodiments of the present disclosure may be in the 10 to 50 watt range, though this range is not considered to be limiting. For example, a 12 watt laser, a 15 watt laser, a 25 watt laser, or a 50 watt laser may be appropriate for use in accordance with embodiments of the present disclosure. Furthermore, CO₂ lasers, YAG lasers, or other appropriate lasers can likewise be used in accordance with embodiments of the present disclosure.

As discussed herein, the present orthodontic brackets can be laser etched on its tooth attachment surface. Without being bound by any particular theory, it is believed that laser etching after sintering provides for an attachment surface that provides an increased and more predictable bonding strength as the laser etched surface maintains clean edges with better uniformity and regularity than a bracket that is laser etched prior to sintering (green body laser etching). Notably, laser etching prior to sintering does not provide the same finished etched surface of that of the present disclosure, as the sintering effectively “melts” the binder in the green body ceramic, allowing the ceramic material to redistribute or flow further during the sintering process. Furthermore, the resulting structure is significantly different in appearance and structure, and to some degree, function. Laser etched green body ceramic that is subsequently sintered has the appearance of more random waves, pits, peaks, etc. Conversely, the laser etched ceramic orthodontic brackets of the present disclosure (laser etched after sintering) have more of a laser blasted appearance where sintered particle masses are knocked off from the sintered mass.

Generally, the orthodontic brackets of the present disclosure can provide for a Knoop hardness sufficient to withstand the forces common to orthodontic brackets. In one embodiment, the bracket can be sintered to a Knoop hardness of at least 600 HK. In another embodiment, the bracket can be sintered to a Knoop hardness of at least 1000 HK. It is notable that typically, the sintered orthodontic brackets have already achieved its finished or near-finished hardness prior to undergoing the laser etching process described herein.

### EXAMPLES

The following examples illustrate a number of variations of the present brackets, systems, and methods that are presently known. However, it is to be understood that the following are only exemplary or illustrative of the application of the principles of the present disclosure. Numerous modifications and alternatives may be devised by those skilled in the art without departing from the spirit and scope of the present disclosure. The appended claims are intended to cover such modifications and arrangements. Thus, while the present brackets, systems, and methods have been described above with particularity, the following examples provide further detail in connection with what are presently deemed to be acceptable.

### Example 1

### Laser Etched Sintered Ceramic Orthodontic Bracket (LA12)

A polycrystalline alumina ceramic material is formed into a desired orthodontic bracket shape using a mold. The ceramic bracket is removed from the mold as a green body, i.e. prior to sintering. The bracket is inspected with removal of asperities, and then sintered. In this example, the sintered bracket is shaped for attachment to a lower anterior tooth (LA12), and the tooth attachment surface has a surface area of 0.0165 in². The sintered bracket is then laser etched on its tooth attachment surface providing 0.5 linear mm of laser etched lines. Line depth in this example can range from about 0.05 to about 3 mm. Furthermore, a 15 Watt YAG laser can be used to modify the tooth attachment surface as described above, though other lasers with different power settings can alternatively be used, provided they generate enough power to modify the tooth attachment surface as described.

### Example 2

### Comparative Sintered Ceramic Orthodontic Bracket

A comparative bracket is manufactured according to the process of Example 1 except the bracket is not laser etched.

### Example 3

### Laser Etched Sintered Ceramic Orthodontic Bracket (UR1)

A polycrystalline alumina ceramic material is formed into a desired orthodontic bracket shape using a mold. The ceramic bracket is removed from the mold as a green body, i.e. prior to sintering. The bracket is inspected with removal of asperities, and then sintered. In this example, the sintered bracket is shaped for attachment to an upper incisor (UR1), and the tooth attachment surface has a surface area of 0.0232 in². The sintered bracket is then laser etched on its tooth attachment surface providing 1.0 linear mm of laser etched lines. Line depth in this example can range from about 0.05 to about 3 mm. Furthermore, a 15 Watt YAG laser can be used to modify the tooth attachment surface as described above, though other lasers with different power settings can alternatively be used, provided they generate enough power to modify the tooth attachment surface as described.

### Example 4

### Comparative Sintered Ceramic Orthodontic Bracket

A comparative bracket is manufactured according to the process of Example 1 except the bracket is not laser etched.

### Example 5

### Comparative Data

A series of 20 laser etched sintered ceramic orthodontic brackets of Examples 1 and 3, and 20 comparative sintered orthodontic brackets of Example 2 and 4, respectively, were bonded to one inch diameter sand blasted (50 μm aluminum oxide) acrylic balls with Opal Bond MV adhesive. Average bonding strength of the respective bracket types was determined by wrapping a wire around each bracket and pulling on the bracket along a tangent line of the acrylic ball circumference using an INSTRON® Machine Model No. 4442. The average bonding strength of each type of bracket is shown in Table 1, as follows:

TABLE 1

| | Bonding Strength |
|---|---|
| | (Pounds of Force) |
| Example 1 (LA12) | 30.7 lbf |
| Example 2 (LA12 comparative) | 21.7 lbf |
| Example 3 (UR1) | 37.4 lbf |
| Example 4 (UR1 comparative) | 20.7 lbf |

As shown in Table 1, the brackets of Examples 1 and 3 had a superior bonding strength as compared to their relative comparative brackets (Examples 2 and 4, respectively). Furthermore, though the comparative example brackets of Examples 2 and 4 had an acceptable average bonding strength to begin with, e.g., above 15 pounds of force, the bonding strength of each was improved by at least 1.4 times over and the bonding strength provided inherently by the surface area, material choice, and adhesive choice of its comparative bracket. By applying the laser etching differently on the tooth attachment surface than as described in the present Examples, more or less of an increase in average bonding strength can be achieved (e.g., increases in bonding strength as low as 1.05 times greater to increases in bonding strength greater than 2.0 times are achievable). In this specific circumstance, by selecting appropriately configured laser etching of the tooth attachment surface, including appropriate length of linear laser etching, the bonding strength was indeed increased, but not so much as to be too strong, e.g., increased to less than 40 pounds of force. Thus, laser etching of the tooth attachment surface can be used to modulate or achieve a more precise average bonding strength for a given set of bracket/adhesive choices (bracket size, bracket material, bracket shape, adhesive choice, etc.).

While the disclosure has been described with reference to certain examples, those skilled in the art will appreciate that various modifications, changes, omissions, and substitutions can be made without departing from the spirit of the disclosure. It is intended, therefore, that the invention be limited only by the scope of the following claims.

What is claimed is:

1. A sintered ceramic orthodontic bracket, comprising:
a working surface including an archwire slot and a ligating structure; and
a laser etched tooth attachment surface which is laser etched after sintering of the ceramic orthodontic bracket.

2. The sintered ceramic orthodontic bracket of claim 1, wherein the entire orthodontic bracket is ceramic.

3. The sintered ceramic orthodontic bracket of claim 1, wherein the laser etched tooth attachment surface provides an average bonding strength of about 15 to about 40 pounds of force.

4. The sintered ceramic orthodontic bracket of claim 3, wherein the average bonding strength is from about 20 to 35 pounds of force.

5. The sintered ceramic orthodontic bracket of claim 1, wherein the sintered ceramic orthodontic bracket provides for an average bonding strength that is at least 1.05 times that of a comparison sintered ceramic bracket that is not laser etched.

6. The sintered ceramic orthodontic bracket of claim 5, wherein the average bonding strength is at least 1.4 times that of a comparison sintered ceramic bracket that is not laser etched.

7. The sintered ceramic orthodontic bracket of claim 1, wherein the sintered ceramic orthodontic bracket comprises polycrystalline alumina, monocrystalline zirconia, or combinations thereof.

8. The sintered ceramic orthodontic bracket of claim 1, wherein the archwire slot includes a metal slot liner.

9. The sintered ceramic orthodontic bracket of claim 1, wherein the ligating structure includes a plurality of tie wings.

10. The sintered ceramic orthodontic bracket of claim 1, wherein the ligating structure includes a self-ligating structure.

11. The sintered ceramic orthodontic bracket of claim 1, wherein the bracket is sintered to a Knoop hardness of at least 600 HK prior to being laser etched.

12. The sintered ceramic orthodontic bracket of claim 1, wherein the bracket is sintered to a Knoop hardness of at least 1000 HK prior to being laser etched.

13. The sintered ceramic orthodontic bracket of claim 1, wherein the laser etched tooth attachment surface includes laser-generated cross-hatching, parallel lines, or design patterning.

14. The sintered ceramic orthodontic bracket of claim 1, wherein the laser etched tooth attachment surface includes from about 0.01 to about 10 linear mm of laser etched lines.

15. The sintered ceramic orthodontic bracket of claim 1, wherein the laser etched tooth attachment surface includes from about 0.01 to about 5 linear mm of laser etched lines.

16. The sintered ceramic orthodontic bracket of claim 1, wherein the laser etched tooth attachment surface includes from about 0.02 to about 2 linear mm of laser etched lines.

17. The sintered ceramic orthodontic bracket of claim 1, wherein the laser etched tooth attachment surface includes laser etched lines ranging from about 0.01 mm to about 1 mm in depth.

18. The sintered ceramic orthodontic bracket of claim 1, wherein the laser etched tooth attachment surface includes laser etched lines ranging from about 0.05 mm to about 0.3 mm in depth.

19. A method of increasing the average bonding strength of a sintered ceramic orthodontic bracket, comprising laser etching a tooth attachment surface of the sintered ceramic orthodontic bracket.

20. The method of claim 19, further comprising the preliminary steps of:
forming a ceramic material into a shape of an orthodontic bracket; and
sintering the orthodontic bracket.

21. The method of claim 19, wherein the laser etching provides for an average bonding strength of the sintered ceramic orthodontic bracket that is at least 1.05 times that of a comparison sintered ceramic bracket that is not laser etched.

22. The method of claim 21, wherein the average bonding strength is at least 1.4 times that of a comparison sintered ceramic bracket that is not laser etched.

23. The method of claim 19, wherein the laser etching is carried out with a laser at a power setting of 10 to 50 watts.

24. An orthodontic system, comprising:
a sintered ceramic orthodontic bracket, comprising a working surface including an archwire slot and a ligating structure, and a laser etched tooth attachment surface which is laser etched after sintering of the ceramic orthodontic bracket, and
an adhesive for attaching the sintered ceramic orthodontic bracket to the enamel of a tooth,
wherein the laser etched tooth attachment surface combined with the adhesive provides an average bonding strength of about 15 to about 40 pounds of force.

25. The orthodontic system of claim 24, wherein the entire orthodontic bracket is ceramic.

26. The orthodontic system of claim 24, wherein the average bonding strength is from about 20 to 35 pounds of force.

27. The orthodontic system of claim 24, wherein the sintered ceramic orthodontic bracket provides for an average bonding strength that is at least 1.05 times that of a comparison sintered ceramic bracket that is not laser etched.

28. The orthodontic system of claim 27, wherein the average bonding strength is at least 1.4 times that of a comparison sintered ceramic bracket that is not laser etched.

29. The orthodontic system of claim 24, wherein the sintered ceramic orthodontic bracket comprises polycrystalline alumina.

30. The orthodontic system of claim 24, wherein the archwire slot includes a metal slot liner.

31. The orthodontic system of claim 24, wherein the ligating structure includes a plurality of tie wings.

32. The orthodontic system of claim 24, wherein the ligating structure includes a self-ligating structure.

33. The orthodontic system of claim 24, wherein the bracket is sintered to a Knoop hardness of at least 600 HK prior to being laser etched.

34. The orthodontic system of claim 24, wherein the bracket is sintered to a Knoop hardness of at least 1000 HK prior to being laser etched.

35. The orthodontic system of claim 24, wherein the laser etched tooth attachment surface includes from about 0.01 to about 10 linear mm of laser etched lines.

36. The orthodontic system of claim 24, wherein the laser etched tooth attachment surface includes from about 0.01 to about 5 linear mm of laser etched lines.

37. The orthodontic system of claim 24, wherein the laser etched tooth attachment surface includes from about 0.02 to about 2 linear mm of laser etched lines.

38. The orthodontic system of claim 24, wherein the laser etched tooth attachment surface includes laser etched lines ranging from about 0.01 mm to about 1 mm in depth.

39. The orthodontic system of claim 24, wherein the adhesive is a methacrylate monomer-based composite.

40. The orthodontic system of claim 24, wherein the adhesive includes bisphenol A diglycidylether methacrylate, bisphenol A bis(2-hydroxyethyl ether)dimethacrylate, silane treated quartz, silica, alumina, silane treated silica or alumina, or mixtures thereof.
